(19) United States
(12) Patent Application Publication
(10) Pub. No.: US 2012/0256884 A1
(43) Pub. Date: Oct. 11, 2012

(54) Sport-Strator

(76) Inventor: R. R. Goyakla Apache, Las Vegas, NV (US)

(21) Appl. No.: 13/219,095

(22) Filed: Aug. 26, 2011

Related U.S. Application Data
(60) Provisional application No. 61/516,513, filed on Apr. 5, 2011.

(51) Int. Cl. G06F 3/033

(52) U.S. Cl. 345/179

(57) ABSTRACT

The “Sport-Strator” is a graphics tablet with an underlying monitor in synchronicity of display to a television with which it communicates. With use of a stylus, a user can draw images upon the graphics tablet that will appear on the television displaying that same monitor-received broadcast.

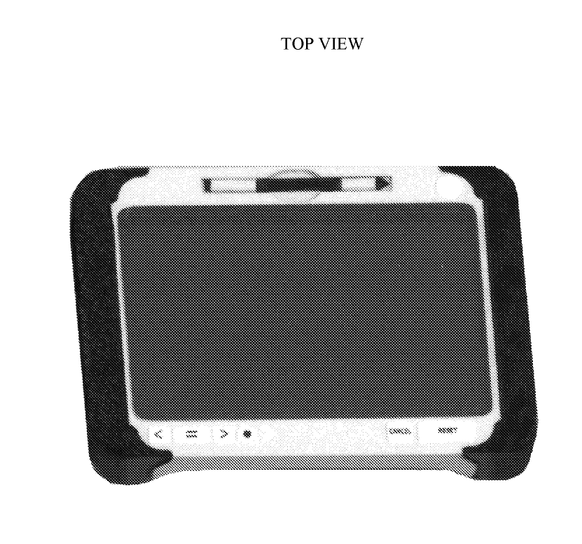

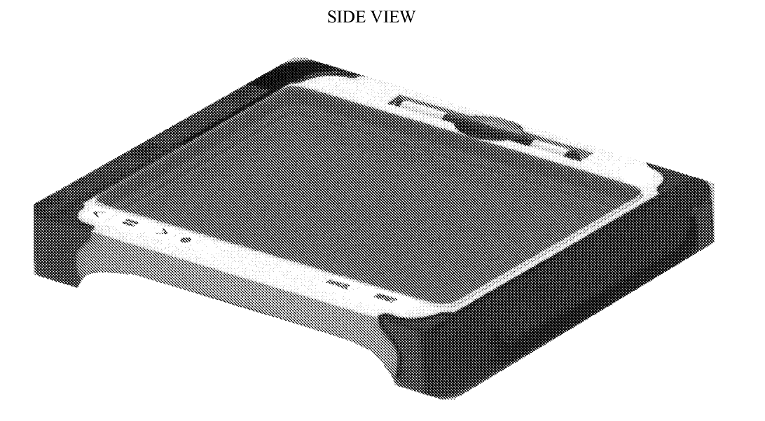

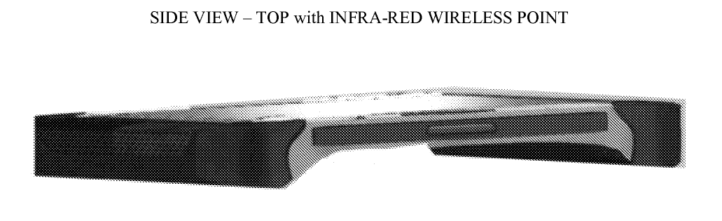

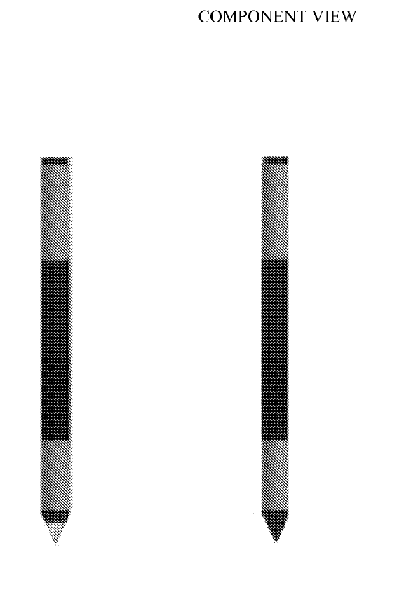

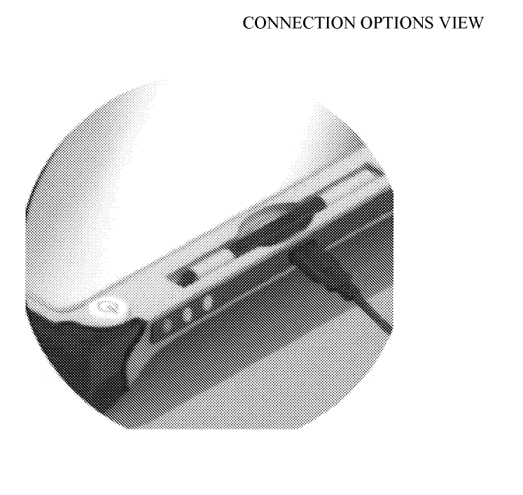

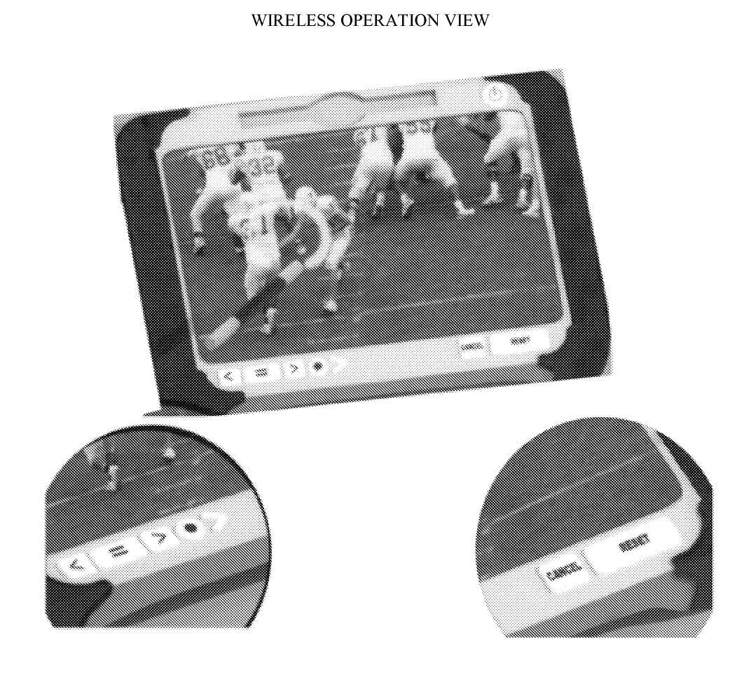

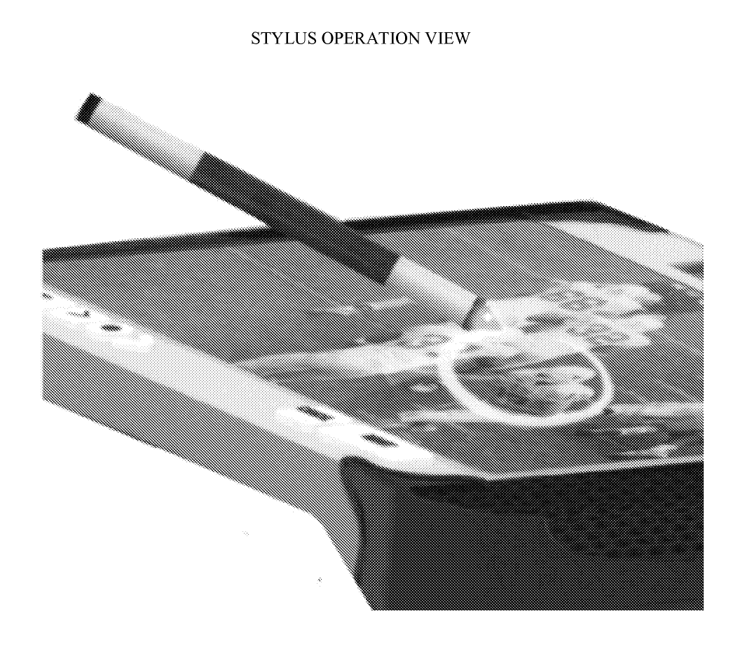

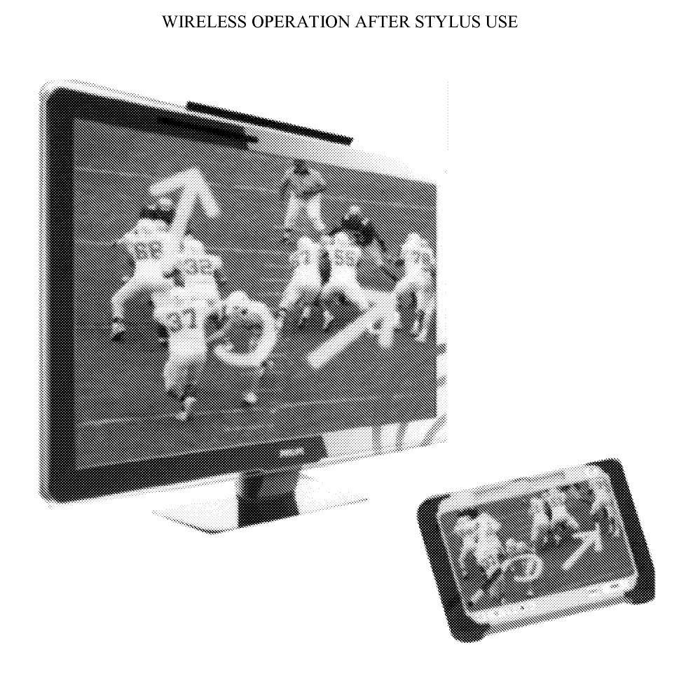

### CROSS-REFERENCE TO RELATED APPLICATIONS

A prior provisional patent application was submitted on this current non-provisional utility patent application.

### Provisional Patent Application:

Inventor: R.R. Goyakla Apache

Application No. 61/516,513

Filing Date Apr. 5, 2011

Confirmation Number 5834

The following patent applications relate to my non-provisional utility patent application and are listed below

### Related Patents:

U.S. Pat. No. 5,610,653 Mar. 11, 1997

U.S. Pat. No. 6,496,196 B2 Dec. 17, 2002

U.S. Pat. No. 4,591,897 May 27, 1986

U.S. Pat. No. 7,075,556 B1 Jul. 11, 2006

U.S. Pat. No. 7,240,075 B1 Jul. 3, 2007

U.S. Pat. No. 2009/0128580 A1 May 21, 2009

U.S. Pat. No. 7,492,363 B2 Feb. 17, 2009

U.S. Pat. No. 2006/0087504 Al Apr. 27, 2006

U.S. Pat. No. 4,612,666 Sep. 16, 1986

### STATEMENT REGARDING FEDERALLY SPONSORED RESEARCH

Not Applicable

### BACKGROUND OF THE INVENTION

The concept of the invention came during watching John Madden provide color commentary on NFL football games. His descriptions of the plays typically involved his using a stylus to telestrate upon the screen the movement of the players during a sequence of plays. This enhanced the viewing experience of the audience. However, this was a passive enhancement. The Sport-Strator was devised to allow the viewing audience to take an active role in watching televised events and thus increase their interactive experience. Essentially getting them more involved with the broadcast they are viewing.

### BRIEF SUMMARY OF THE INVENTION

The “Sport-Strator” is a graphics tablet with an underlying monitor in synchronicity of display to a television with which it communicates. With use of a stylus, a user can draw images upon the graphics tablet that will appear on the television displaying that same monitor-received broadcast.

### BRIEF DESCRIPTION OF THE SEVERAL VIEWS OF THE DRAWING

The patent or application file contains at least one drawing executed in color. Copies of this patent or patent application publication with color drawing(s) will be provided by the Office upon request and payment of the necessary fee.

Drawings Indicia:

Top View—This photo shows the “Sport-Strator” tablet from a top view.

Side View—Photo shows the tablet from a side perspective.

Top Side View—Photo shows the wireless infra-red port on the tablet.

Component View—Photo shows the stylus and the transceiver.

Connection Options View—Photo shows how the tablet is connected through either a RBG plug or a USB plug. Older television sets can be accommodated with these various options.

Wireless Operation View—Photo shows how the wireless connection would operate.

Stylus Operation View—Photo shows how the stylus would be used on the tablet.

Wireless Operation after Stylus Use—Photo shows what the operation would look like after the stylus use on the tablet through wireless connection.

### DETAILED DESCRIPTION OF THE INVENTION

The “Sport-Strator” features a graphics tablet, a video monitor built into that graphics tablet, and a stylus that can be used upon that graphics tablet. A transceiver assembly communicates resultant signals from this graphics tablet to a television, the broadcast received by said television displays upon the aforementioned monitor, and for display of graphics upon that television. Control buttons for the prompting of actions are also featured upon the hosting frame of the graphics tablet. The graphics tablet features a rubberized material about its outer perimeter to provide grip enhancement and shock absorption.

### Mechanical Description

The monitor of the “Sport-Strator” is of liquid crystal display (LCD) format, and is placed within the two (2) planes of a graphics tablet. This graphics tablet is of passive class, designed in matrix approach, and with grid alignment between these two (2) planes. The monitor-encasing graphics tablet is included within a surrounding frame. The surrounding frame includes operating controls for particular functions of the “Sport-Strator”, including play, rewind, fast forward, pause, clear, and reset. The stylus used with this graphics tablet includes an LC circuit of resonant circuit format, and for communication with the grids in the monitor. The communication of that topographical formulation is sent by a transmitter included within the graphics tablet to a receiver. This receiver is attached to a television, and for communication of the graphic images received by the graphics tablet upon that same television.

### Usage

A user may attach the receiver of the “Sport-Strator” upon a television. Upon saving or rewinding any image upon that television, followed by the pause function, he or she may use the stylus to create images upon the broadcast, and with the purpose of applying personalized interpretation. The images created by the user through the stylus will then be displayed upon the television in accompaniment to its broadcast signal.

1. The monitor of the “Sport-Strator” is of liquid crystal display (LCD) format, and is placed within the two (2) planes of a graphics tablet.
This graphics tablet is of passive class, designed in matrix approach, and with grid alignment between these two (2) planes.
The monitor-encasing graphics tablet is included within a surrounding frame. The surrounding frame includes operating controls for particular functions of the “Sport-Strator”, including play, rewind, fast forward, pause, clear, and reset.
The stylus used with this graphics tablet includes an LC circuit of resonant circuit format, and for communication with the grids in the monitor.
The communication of that topographical formulation is sent by a transmitter included within the graphics tablet to a receiver.
This receiver is attached to a television, and for communication of the graphic images received by the graphics tablet upon that same television.
The “Sport-Strator” can initiate pause functions within these formats of broadcast and television display.
The “Sport-Strator” can initiate replay functions within these formats of broadcast and television display.
The “Sport-Strator” allows users to recapture segments of broadcast with personalized observation.
The “Sport-Strator” allows users to graphically note particular facets of broadcast for others to visually note.
The “Sport-Strator” may use various formats of tablets for interaction with its accompanying stylus, including but not limited to passive, active, optical, acoustic, capacitive and electromagnetic formats.
The “Sport-Strator” may use a puck instead of a stylus.
The receiving interaction between the stylus and graphics tablet can be of matrix approach or capacitive shunt method.
The “Sport-Strator” can be produced in formats containing an integral digital video recording device, and in such formats secondary time-shifting methods would not be necessary.
The “Sport-Strator” can be packaged for retail sale with an accompanying digital video recording device.
The “Sport-Strator” can be packaged for retail sale incorporated within a digital video recording device.
The “Sport-Strator” can be packaged for retail sale incorporated within a desktop computer or laptop computer.
The “Sport-Strator” can be packaged for retail sale incorporated within an internet ready or Wi-Fi enhanced tablet.
The “Sport-Strator” can be packaged for retail sale incorporated within an internet ready or Wi-Fi enhanced television.
Invention Benefits:
The “Sport-Strator” provides television viewers with means of direct interaction with television broadcasts.
The “Sport-Strator” allows users to apply personal interaction to their viewings.
The “Sport-Strator” allows such personal interaction to take a graphic format.
The “Sport-Strator” can accept hand-drawn lines and images upon its graphics tablet.
The “Sport-Strator” can display those hand-drawn lines and images upon a television screen.
The “Sport-Strator” allows users to operate a Telestrator®-type function while viewing television.
The “Sport-Strator” allows users to play an active role in entertainment broadcast.
The “Sport-Strator” allows users to participate in a renowned addition to sports broadcasting.
The “Sport-Strator” increases viewer interest in sports and other broadcasting.
The “Sport-Strator” increases viewer enjoyment and participation in sports and other broadcasting.
The “Sport-Strator” allows users to display personal observations on sports broadcasts in a visual format.
The “Sport-Strator” can be used for interaction with all types of broadcast sporting events, such as but not limited to football, soccer, basketball, baseball and other sports.
The “Sport-Strator” cooperates with popular formats of broadcast and television display.
The “Sport-Strator” can be used with DirecTV®, TiVo®, and other formats of broadcasting and/or time-shifting.
The “Sport-Strator” can be used with broadcast satellite services that reach over 16 million viewers in the United States.
The “Sport-Strator” can be used with digital video recording services that are used by over 30 million operators in the United States.
The “Sport-Strator” can appeal to the millions of consumers who enjoy watching sporting events.
The “Sport-Strator” allows users to have interaction with broadcasts in the same format that many particular broadcasters use themselves.
The “Sport-Strator” can be used in private homes and in social business environments, including but not limited to sports bars.
The “Sport-Strator” can be used in athletic training and game preparation.
The “Sport-Strator” can be used in many types of video displays and broadcasts.
The “Sport-Strator” can be used as an aide in presentations, seminars and instructional series.
Invention Variations:
The “Sport-Strator” can be made in various sizes.
The “Sport-Strator” can be produced for use with all, or with any specific format(s) of, cable, satellite or digital television broadcasting.
